(19) United States
(12) Patent Application Publication
(10) Pub. No.: US 2024/0035858 A1
(43) Pub. Date: Feb. 1, 2024

(54) DEVICE FOR IDENTIFYING LOCATION AND TYPE OF OBJECT

(71) Applicant: Hyun Woo YU, Seoul (KR)

(72) Inventor: Hyun Woo YU, Seoul (KR)

(21) Appl. No.: 18/257,560

(22) PCT Filed: Dec. 13, 2021
(86) PCT No.: PCT/KR2021/018877

§ 371 Date: Jun. 14, 2023

(30) Foreign Application Priority Data
Dec. 22, 2020 (KR) 10-2020-0180764

(51) Int. Cl. G01D 5/20

(52) U.S. Cl. CPC G01D 5/20

(57) ABSTRACT

A device for identifying the location and type of an object according to the present invention comprises: a transmission and reception coil in which a conductive wire is wound concentrically and multiple times; a selection circuit for selectively connecting one end portion of the conductive wire of the transmission and reception coil to a first circuit end or a second circuit end; an output circuit formed to apply an alternating current of a first frequency to the first circuit end; a reception circuit for receiving an induced voltage applied to the second circuit end; and a control circuit for controlling the operation of the selection circuit to connect the output circuit to the one end portion of the transmission and reception coil in a transmission mode and connect the reception circuit to the one end portion of the transmission and reception coil in a reception mode, controlling the output circuit to apply the alternating current of the first frequency to the first circuit end in the transmission mode, and determining if a predetermined resonant circuit has come near the transmission and reception coil, by analyzing the peak or strength of the induced voltage received by the reception circuit in the reception mode.

### TECHNICAL FIELD

The present invention relates to a device for detecting the approach of an object to a transmitting and receiving coil and identifying the object.

### BACKGROUND ART

There have been various methods for detecting the location of an object, in particular, an object including a resonant circuit. As an example, Korean Patent Application Publication No. 2016-0088655 (Jul. 26, 2016), entitled “stylus pen, touch panel and coordinate measurement system having same” (hereinafter referred to as the “prior art”) is presented.

As shown in FIG. 1, the system of the prior art includes a plurality of antenna patterns, wherein each antenna pattern has a shape surrounded by the border of a long bar and opened at one side, and thus the shape of each antenna pattern is not completely surrounded even once. Further, the system identifies the position of an electronic pen by determining the antenna pattern closest to the electronic pen through measuring the intensity of induced voltages generated in each antenna pattern by electromagnetic waves emitted from the electronic pen.

However, in the system of the prior art that uses bar-shaped antenna patterns, antenna patterns arranged in a first axis direction and another antenna patterns arranged in a second axis direction must be provided in order to determine the position of the electronic pen in a two-dimensional coordinate system as two-dimensional coordinates.

Furthermore, since the prior art system has the antenna patterns not completely surrounded even once, sufficiently strong induced voltages are not generated in the antenna patterns, resulting in low accuracy or precision in detecting the position of the electronic pen. Further, the prior art system is difficult to detect a plurality of electronic pens simultaneously.

### DISCLOSURE

### Technical Problem

An object of the present invention is to provide a device capable of accurately and precisely detecting an approach of an object to a transmitting and receiving coil and a location of the object, and simultaneously and also accurately distinguishing different objects from each other.

### SUMMARY

According to an embodiment, a device for identifying the location and the type of an object, the device may comprises: a transmitting and receiving coil composed of a wire wound concentrically and plurality of times; a selection circuit configured to selectively couple one end of the wire of the transmitting and receiving coil to either one of a first circuit-side end and a second circuit-side end of the selection circuit; an output circuit configured to apply an alternating current of a first frequency to the first circuit-side end; a receiving circuit configured to receive an induced voltage applied to the second circuit-side end; and a control circuit. Wherein the control circuit may be configured to:—control the operation of the selection circuit such that the selection circuit couples the output circuit to the one end of the transmitting and receiving coil in a transmission mode and couples the receiving circuit to the one end of the transmitting and receiving coil in a receive mode; —in the transmission mode, control the output circuit to apply the alternating current of the first frequency to the first circuit-side end; and—in the receive mode, determine whether a resonant circuit has approached the transmitting and receiving coil by analyzing the peak or the intensity of the induced voltage received by the receiving circuit. Wherein the resonant circuit is configured to generate energy by resonating with the electromagnetic wave at the first frequency emitted from the transmitting and receiving coil in the transmission mode, and to emit electromagnetic waves having its own resonant frequency by the generated energy when emission of the electromagnetic waves at the first frequency is stopped in the receive mode.

According to a further embodiment, wherein the control circuit identifies the resonant circuit by analyzing the frequency of the induced voltage, in the receive mode.

According to a further embodiment, the device comprises a plurality of transmitting and receiving coils, the selection circuit is configured to select at least one of the one ends of the plurality of transmitting and receiving coils, and couple the selected at least one end thereof to either of the first circuit-side end or the second circuit-side end, the control circuit is configured to cause at least one of the plurality of transmitting and receiving coils to emit electromagnetic waves at the first frequency in the transmission mode and to determine the location of the resonant circuit by determining a transmitting and receiving coil which receives a maximum value of induced voltage.

According to a further embodiment, wherein the other ends of the plurality of transmitting and receiving coils are coupled to a common voltage.

According to a further embodiment, wherein the plurality of transmitting and receiving coils comprises transmitting and receiving coils of a first layer which are disposed on a first surface and transmitting and receiving coils of a second layer which are disposed on a second surface, the second surface being apart from the first surface, the transmitting and receiving coils of the first layer and the transmitting and receiving coils of the second layer being misaligned with each other.

According to a further embodiment, wherein the control circuit is configured to cause all of the plurality of transmitting and receiving coils to simultaneously emit electromagnetic waves at the first frequency by coupling all of the plurality of transmitting and receiving coils to the output circuit, in the transmission mode, and the control circuit is configured to select two or more transmitting and receiving coils that are not adjacent to each other and to analyze induced voltages from the two or more transmitting and receiving coils, in the receive mode.

According to a further embodiment, wherein the resonant circuit comprises: at least one resonant coil and at least one resonant capacitor designed such that the resonant frequency of the resonant circuit is equal to the first frequency; and at least one additional capacitor connected to the at least one resonant capacitor in series or parallel to vary the resonant frequency.

According to a further embodiment, wherein the at least one additional capacitor further comprises: a variable capacitor the capacitance of which is varied by an external physical force, or a switch that is switched by the physical force to turn on/off the connection between the at least one additional capacitor and the at least one resonant capacitor.

According to a further embodiment, wherein the control circuit is configured to cause the respective one of the transmitting and receiving coils to operate the transmission mode and the receive mode a plurality of times, and in each time of the repetitions, and wherein the control circuit is configured to: in the transmission mode, cause the output circuit to output alternating currents of different frequencies such that electromagnetic waves of the different frequencies are transmitted from the transmitting and receiving coil; and in the receive mode, analyze the peak or the intensity of the received induced voltage and determine the resonant frequency of the resonant circuit among different frequencies of the alternating currents, and thereby identifies the resonant circuit.

### Effect of the Invention

The device for determining location of object and distinguishing said object according to the present invention can accurately detect whether an object approaches one of the transmitting and receiving coils, and can accurately distinguish between different objects.

Furthermore, the device for determining location of object and distinguishing said object according to the present invention has high accuracy and precision (resolution) for determining location of an object and distinguishing said object, due to the use of a plurality of transmitting and receiving coils and due to the optimal arrangement of the transmitting and receiving coils.

Furthermore, the device for determining location of object and distinguishing said object according to the present invention is implemented such that the resonant frequency of the resonant circuit can be arbitrarily varied by a user, thus the device can be utilized for various purposes in combination with various objects equipped with resonant circuits.

### BRIEF DESCRIPTION OF THE DRAWINGS

FIG. 1 schematically shows an operating principle of a touch panel and a coordinate measurement system, according to the prior art.

FIG. 2 shows a schematic configuration and operating principle of a device for determining the location of an object and distinguishing said object, according to the present invention.

FIG. 3 shows example of various forms of the transmitting and receiving coils.

FIG. 4 shows a principle of distinguishing a resonant circuit using a transmitting and receiving coil.

FIG. 5 shows a principle of distinguishing for resonant circuits with different resonant frequencies using a transmitting and receiving coil.

FIG. 6 shows the intensities of induced voltages generated at a transmitting and receiving coil when electromagnetic waves emitted from resonant circuits having different resonant frequencies are received.

FIG. 7 shows in detail steps for processing signals of induced voltages generated by a transmitting and receiving coil in a device for determining the location of an object and identifying the object, according to the present invention.

FIG. 8 shows a device for determining a location of an object and distinguishing said object utilizing a plurality of transmitting and receiving coils, according to another embodiment of the present invention.

FIG. 9 shows an example of arranging a plurality of transmitting and receiving coils.

FIG. 10 shows a principle of determining a location of a resonant circuit using the plurality of transmitting and receiving coils arranged on each of two layers shown in FIG. 9.

FIG. 11 shows an example of an object having one or more resonant circuits.

FIG. 12 shows another example of an object having a plurality of resonant circuits.

FIG. 13 shows an example of an object with a push switch.

FIG. 14 shows an example of an object implemented in the form of an electronic pen.

FIG. 15 shows an example in which various objects are arranged and utilized in various ways, in a device for determining location of object and distinguishing said object.

FIG. 16 shows a principle of operating a device for determining a location of an object and distinguishing said object, according to other embodiment of the present invention.

### DETAILED DESCRIPTION

Hereinafter, the various embodiments of a device for determining a location of an object and distinguishing said object according to the present invention will be described with reference to the accompanying drawings.

In particular, the terms referring to each component in the present disclosure are terms defined in consideration of the functions of the components, and thus it should not be understood that the technical content of the present disclosure is predicted and limited by the terms themselves.

Furthermore, the various embodiments of the invention to be described below are intended only to show the technical details of the invention, and the scope of protection of the invention is to be construed in accordance with the accompanying claims. Furthermore, one having ordinary skilled in the technical field to which the invention belongs will be able to design various modifications and variations without departing from the essential features of the invention, and the scope of the invention should be construed to cover all technical ideas that are equally within the scope of the invention.

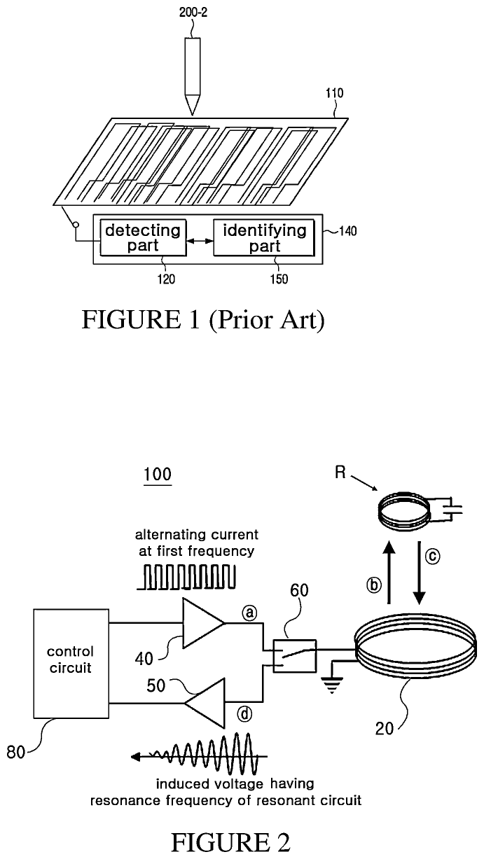

First, referring to FIG. 2, a schematic configuration and operating principle of a device for determining the location of an object and identifying the object according to the present invention will be described. Referring to FIG. 2, the device 100 for determining the location of an object and identifying the object of the present invention can comprise a transmitting and receiving coil 20, an output circuit 40, a receiving circuit 50, a selection circuit 60, and a control circuit 80. Of course, the device 100 may further comprise a resonant circuit R as a detection target of the location and the type.

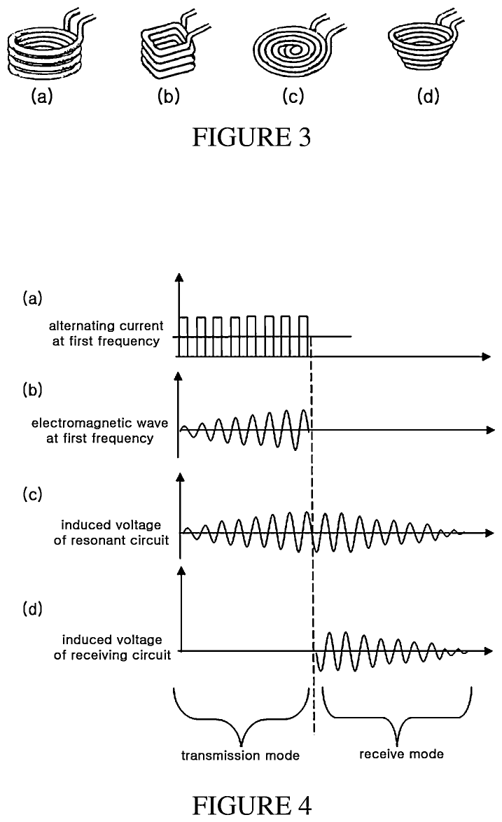

The transmitting and receiving coil 20 can be formed in a shape where a wire has undergone at least one concentric rotation. As shown in FIG. 3, the shape of the coil can include (a) a circular coil shape of a concentrically and vertically arranged coil of the same size, (b) a polygonal coil shape of a vertically arranged concentric polygonal coil of the same size, (c) a pancake shape arranged in a spiral shape on a plane, or (d) a vortex shape formed by vertically moving in a concentric manner with varying size. However, in order to simply forming the coil on a substrate, the shape (c) of the coil is most preferred.

One terminal (hereinafter referred to as “one end”) of the wire composing the transmitting and receiving coil 20 can be coupled to the selection circuit 60, and the other terminal (hereinafter referred to as “the other end”) of the wire can be coupled to ground or a common voltage.

The selection circuit 60 can have two ends on the circuit side and one end on the coil side. The one end of the transmitting and receiving coil 20 can be coupled to the coil-side end of the selection circuit 60. A first circuit-side end of the selection circuit 60 can be coupled to an output of the output circuit 40, and a second circuit-side end can be coupled to an input of the receiving circuit 50. The selection circuit 60 is operable to couple the coil-side end thereof to either of the first circuit-side end and the second circuit-side end thereof according to control of the control circuit 80.

The output circuit 40 generates an alternating current of a predetermined frequency (for example, a first frequency) using an inputted power supply voltage (for example, when the selection circuit selects the first circuit-side end, in a transmission mode), and applies the generated alternating current of the predetermined frequency (for example, the first frequency) to the transmitting and receiving coil 20 via an output. Accordingly, the transmitting and receiving coil 20 emits electromagnetic waves of the first frequency in the air by the inputted alternating current.

The receiving circuit 50 receives an induced voltage inputted from the second circuit-side end (for example, when the selection circuit selects the second circuit-side end, in the receive mode), and transmits the received induced voltage to the control circuit 80 coupled to the output, wherein the induced voltage is generated by resonance of the transmitting and receiving coil 20.

The control circuit 80 is configured to control the selection operation of the selection circuit 60, control the alternating current output operation of the output circuit 40, and analyze the induced voltage provided by the receiving circuit 50. The control circuit 80 can operate in both the transmission mode and the receive mode.

First, in the transmission mode, the control circuit 80 can control the operation of the selection circuit 60 such that the alternating current outputted from the output circuit 40 is applied to the transmitting and receiving coil 20, that is, such that the coil-side end and the first circuit-side end are coupled each other. Further, the control circuit 80 can control the output circuit 40 to generate and output the alternating current of the first frequency.

Furthermore, in the receive mode, the control circuit 80 can control the operation of the selection circuit 60 such that the receiving circuit 50 receives the induced voltage from the transmitting and receiving coil 20, that is, such that the coil-side end and the second circuit-side end are coupled each other. Further, the control circuit 80 can determine whether a predetermined resonant circuit R has approached the vicinity of the transmitting and receiving coil 20 by analyzing the peak, intensity, and/or frequency of the induced voltage received at the input of the receiving circuit 50.

The resonant circuit R can comprise at least one resonant coil L and at least one resonant capacitor C which are configured such that a resonant frequency is matched the first frequency. Here, the resonant frequency of the resonant circuit R can either be exactly the same as the first frequency, or have some difference from the first frequency. This difference is such that the resonant circuit R can sufficiently resonate with electromagnetic waves of the first frequency in the transmission mode and thus can induce sufficient resonance of the transmitting and receiving coil 20 in the receive mode.

Furthermore, the resonant circuit R can comprise at least one additional capacitor C2, C3 coupled in series or parallel with the resonant capacitor C to vary the resonant frequency. Here, as described above, the resonant frequency can be selected within a range where the resonant circuit R can generate sufficient energy in the transmission mode, and where the peak, intensity, and/or variation of the electromagnetic waves emitted from the resonant circuit R can be detected sufficiently by the transmitting and receiving coil 20 in the receive mode.

Meanwhile, the additional capacitors C2, C3 can include, for example, a variable capacitor the capacitance of which is varied by an externally applied physical force such as a pressing or twisting force by a user, or a switch that is switched by the physical force to turn on or off the series or parallel coupling of the additional capacitor to the resonant capacitor.

The resonant circuit R can generate an induced voltage by resonating with electromagnetic waves of the first frequency emitted from the transmitting and receiving coil 20 because the resonant frequency of the resonant capacitor R corresponds basically to the first frequency. The closer the resonant frequency is to the first frequency, the larger the peak and intensity of the induced voltage generated in the resonant circuit R will be. However, even if the resonant frequency of the resonant circuit R does not exactly match the first frequency, for example, if the resonant frequency of a resonant circuit R is within a certain range of frequencies from the first frequency, the resonant circuit can still resonate at the first frequency, although it cannot be optimal in terms of efficiency, and generate an induced voltage oscillating at the first frequency. However, the peak and intensity of the induced and generated voltage will be reduced, resulting in a smaller amount of energy being generated.

Meanwhile, in the resonant circuit (R) designed to having a different resonant frequency from the first frequency, when the electromagnetic waves of the first frequency emitted from the transmitting and receiving coil (20) is stopped (when the control circuit is switched to the receive mode), the resonant circuit R transmits electromagnetic waves by the energy generated by and stored in the resonant circuit, wherein the electromagnetic waves correspond to its own resonant frequency rather than the first frequency.

Meanwhile, the transmitting and receiving coil 20 receives electromagnetic waves of the resonant frequency outputted from the resonant circuit R, and generates an induced voltage corresponding to the resonant frequency. The induced voltage having the resonant frequency is then transmitted to the control circuit 80, and the control circuit 80 can determine the approaching distance and/or location of the resonant circuit R to the transmitting and receiving coil 20 and/or the type of the resonant circuit R, by analyzing the peak, intensity, and/or resonant frequency of the transmitted induced voltage.

These operations are described in more detail with reference to FIG. 4 to FIG. 7.

FIG. 4 shows the basic principle of identifying a resonant circuit using a transmitting and receiving coil.

In transmission mode, the selection circuit connects the output circuit to the transmitting and receiving coil, and the output circuit applies the alternating current of a first frequency (also referred to as the “oscillating frequency”) (which can be measured at point \textcircled{a} in FIG. 2) as shown in part (a) of FIG. 4 to the transmitting and receiving coil. The transmitting and receiving coil emits electromagnetic waves of the first frequency (which can be measured at point \textcircled{b} in FIG. 2) as shown in part (b) of FIG. 4 by the applied alternating current. The resonant circuit is resonated by the emitted electromagnetic waves of the first frequency, and an induced voltage is generated as shown in the left portion of part (c) of FIG. 4 wherein the generated induced voltage appears as an alternating voltage of the first frequency.

When the transmission mode ends and then the receive mode starts, the selection circuit couples the receiving circuit to the transmitting and receiving coil. The selection circuit is configured to select ether one of the output circuit and the receiving circuit, and thus the alternating current outputted from the output circuit cannot reach the transmitting and receiving coil. Therefore, the transmission of electromagnetic waves of the first frequency from the transmitting and receiving coil is stopped. At this time, the resonant circuit self-oscillates by the energy stored in a resonant capacitor and emits electromagnetic waves. Furthermore, the resonant circuit will emit electromagnetic waves corresponding to its own resonant frequency (which can be measured at point \textcircled{c} in FIG. 2) through a resonant coil, as shown in the right port of part (c) of FIG. 4.

The transmitting and receiving coil can be resonated by the electromagnetic waves of the resonant frequency transmitted from the resonant circuit, and generates an induced voltage (which can be measured at the point \textcircled{d} in FIG. 2) as shown in part (d) of FIG. 4. The induced voltage can be inputted to a control circuit. The induced voltage generated at this time can have a frequency (also referred to as the “response frequency”) corresponding to the resonant frequency and indicate the peak and the intensity. Wherein the peak and the intensity of the induced voltage relates to the distance between the transmitting and receiving coil and the resonant circuit, the direction in which they face each other, and the difference between the first frequency and the resonant frequency.

Based on this principle, the control circuit can determine whether the resonant circuit has approached the transmitting and receiving coil and/or the distance at which the resonant circuit has approached the transmitting and receiving coil, and further, it can also identify the resonant frequency of the resonant circuit.

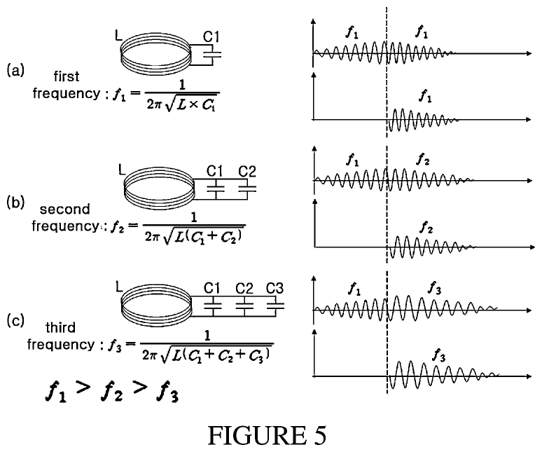

FIG. 5 explains the principle for distinguishing different resonant circuits by identifying the resonant frequencies using the transmitting and receiving coils.

The resonant circuit can include at least one coil (a resonant coil L) and at least one capacitor (a resonant capacitor C1). Here, a resonant frequency of the resonant circuit can be set to match the first frequency by adjusting characteristics of the capacitor C1.

When the resonant circuit the resonant frequency of which coincides the first frequency is close to the transmitting and receiving coil 20, in the transmission mode, the resonant circuit can resonate in response to the first frequency (f1) of the alternating current applied by the output circuit (40), and, in the receive mode, the resonant circuit can emit electromagnetic waves of the resonant frequency corresponding to the first frequency (f1) using the energy stored in the resonant capacitor (C1). Then, the receiving circuit 50 can receive an induced voltage of the first frequency (f1). The observed signal waveform can be shown as part (a) of FIG. 5.

Meanwhile, an arbitrary capacitor i.e., additional capacitor C2 can be added to the resonant circuit. This varies the resonant frequency of the resonant circuit. The varied resonant frequency may be represented by f2. The additional capacitor C2 can be fixedly coupled to the resonant capacitor C1 in series or parallel as shown, or can be coupled through a predetermined switching element.

When this resonant circuit approaches the transmitting and receiving coil 20, in the transmission mode, the resonant circuit resonates at the first frequency f1 and generates an induced voltage by electromagnetic waves of the first frequency f1 emitted from the transmitting and receiving coil 20, with a slightly reduced efficiency although not the maximum efficiency. Meanwhile, in the receive mode, the resonant circuit emits electromagnetic waves by oscillating at its own resonant frequency f2 using the energy accumulated in the capacitors C1 and C2 during the transmission mode, and the transmitting and receiving coil 20 generates an alternating induced voltage having the resonant frequency f2, and then the receiving circuit 50 receives the generated induced voltage. The observed signal waveform can be shown as in part (b) of FIG. 5. It can be seen that the frequency of the induced voltage received by the receiving circuit 50 has slightly varied compared to the frequency of the received waveform shown in part (a) of FIG. 5.

Furthermore, if another additional capacitor C3 is added to the resonant circuit, the resonant frequency of the resonant circuit is shifted further away from the first frequency f1. The shifted resonant frequency is denoted by f3. The resonant circuit will receive the electromagnetic wave of the first frequency f1 during the transmission mode, resonate with a lower efficiency than before, and emit, during the receive mode, the electromagnetic wave corresponding to the resonant frequency f3 using the energy accumulated in the capacitors C1, C2, and C3 (the accumulated energy is less than in part (b) of FIG. 5) during the transmission mode. The transmitting and receiving coil 20 generates an induced voltage corresponding to the resonant frequency f3. FIG. 5(c) shows the observed signal waveform. It can be seen that the frequency of the induced voltage received by the receiving circuit 50 has more significantly varied compared to the frequency of the induced voltage received in part (a) or (b) of FIG. 5.

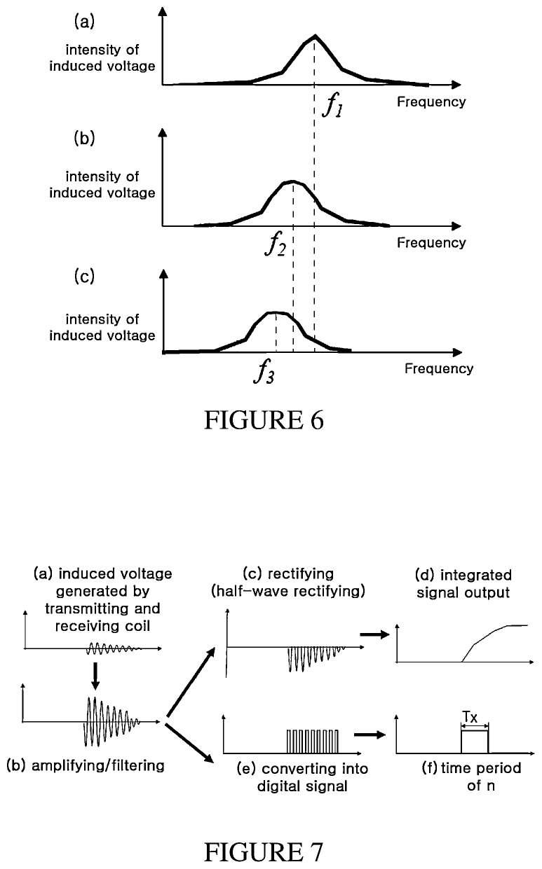

FIG. 6 shows the intensity distributions of the induced voltages at different frequencies, wherein the induced voltages are generated in a transmitting and receiving coil when the transmitting and receiving coil receives electromagnetic waves emitted by resonant circuits having different resonant frequencies. The induced voltages can be measured in the receiving circuit (e.g., at point \textcircled{d} in FIG. 2).

Part (a) of FIG. 6 shows the intensity distribution of the induced voltage generated in a transmitting and receiving coil when the resonant frequency of the resonant circuit coincides with the first frequency, as in part (a) of FIG. 5. Since the resonant frequency coincides with the first frequency, the resonant circuit resonates at maximum efficiency, bringing about a sharp and significant peak at the first frequency (f1). Therefore, in this case, the peak can be easily and accurately detected.

Part (b) of FIG. 6 shows the intensity distribution of the induced voltage generated in the transmitting and receiving coil when the resonant frequency of the resonant circuit is slightly shifted from the first frequency, as shown in part (b) of FIG. 5. Since the resonant frequency has a slight difference from the first frequency, the resonance efficiency of a resonant circuit decreases, resulting in a blunt peak at the second frequency f2 outside of the first frequency. However, even in this case, the peak still exists, and the second frequency f2 can be determined by that peak.

Part (c) of FIG. 6 shows the intensity distribution of the induced voltage generated in the transmitting and receiving coil when the resonant frequency of the resonant circuit is significantly shifted from the first frequency, as shown in part (c) of FIG. 5. Since the resonant frequency is significantly shifted from the first frequency, the resonance efficiency of the resonant circuit decreases even further, resulting in a blunter peak at the third frequency f3 which is greatly shifted from the first frequency. However, even in this case, it is still possible to identify the peak, that is, it is possible to identify that the location of the peak is different from the locations of the first frequency f1 or the second frequency f2, and thus the third frequency f3 can be detected by that peak. The detection of such frequencies is possible because, in reality, the peak of the third frequency is far enough away from the peaks of the first or second frequencies to be identified.

According to this configuration, in the case of objects having resonant circuits with different resonant frequencies, it is possible to identify which object has approached the transmitting and receiving coil on basis of the value of the resonant frequency analyzed.

FIG. 7 shows an example of signal processing steps of an induced voltage generated by a transmitting and receiving coil in a device for identifying the location of an object and identifying the object, according to the present invention.

In the receive mode, the induced voltage generated by the transmitting/receiving circuit can be appeared as shown in part (a) of FIG. 7. Since the induced voltage generated at this time can be very small, it can be amplified as shown in part (b) of FIG. 7. In addition, voltage waveforms other than the induced voltage can be filtered out.

Two types of signal processing can be performed on the amplified and filtered induced voltage.

One signal processing is for measuring the intensity of the generated induced voltage. To do this, the induced voltage can be half-wave rectified (or full-wave rectified) as shown in part (c) of FIG. 7, and then the rectified signal can be integrated. The total sum of the integrated signal as shown in part (d) of FIG. 7, or the sum of values at particular points, can be used for determining the signal intensity of the induced voltage.

On the other hand, another signal processing is for measuring the frequency of the generated induced voltage. To do this, the induced voltage inputted to the receiving circuit can be converted into a digital signal having pulses related to the waveform of the generated induced voltage signal, as shown in part (e) of FIG. 7. Then, by dividing the number of pulses of the digitally converted signal counted during a certain time period as shown in part (f) of FIG. 7, by said time period, the response frequency (Fᵣₑₛₚₒₙₛₑ) can be calculated by equation (1).

Fᵣₑₛₚₒₙₛₑ=n/Tx eq. (1)

Furthermore, as a modified example of a device for determining the location of an object and distinguishing the type of the object, the device can be implemented comprising a plurality of transmitting and receiving coils. And the device can determine the location of a resonant circuit among the locations of the transmitting and receiving coils, by detecting a transmitting and receiving coil that is closest to the resonant circuit based on the intensity of the induced voltage detected in each transmitting and receiving coil.

Further, in another modified example of a device for determining the location of an object and distinguishing the type of the object, the device comprises a plurality of transmitting and receiving coils as described above. Further, the object has resonant circuits of different resonant frequencies disposed at different locations. Thus, the device can distinguish the type, posture, orientation, etc. of the object on the basis of the frequencies of the induced voltages detected by the respective transmitting and receiving coils.

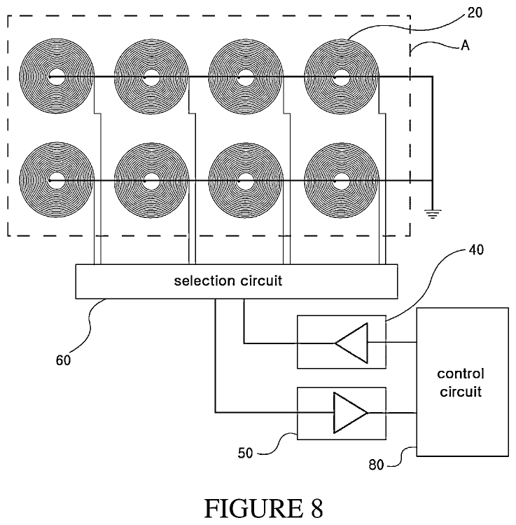

FIG. 8 is a diagram illustrating the device for determining the location of an object and identifying the object by utilizing a plurality of transmitting and receiving coils, as an embodiment that can implement the above application example.

In the embodiment, a plurality of transmitting and receiving coils 20 is implemented, for example, to have the same size and shape by being arranged in a concentric circular pattern of wires, and the plurality of transmitting and receiving coils 20 are arranged adjacent to each other side by side within a predetermined area (hereinafter referred to as “detection area A”). Of course, the respective transmitting and receiving coils 20 can be of different sizes and shapes, and can be placed at various positions with different intervals.

One ends of each of the plurality of transmitting and receiving coils 20 can be each coupled respectively to one of a plurality of coil-side ends provided in the selection circuit 60, and the other end of each of the plurality of transmitting and receiving coils 20 can be coupled to a common ground or common voltage.

Here, the selection circuit 60 preferably has coil-side ends corresponding to the number of one end of each of the plurality of transmitting and receiving coils 20, and preferably has two circuit-side ends for the output circuit 40 and the receiving circuit 50, if possible. The selection circuit 60 can be configured to select any one or any plurality number of coil-side ends, or all of the coil-side ends, and to connect the selected coil-side end(s) to any one of the circuit-side ends, under the control of a control circuit 80.

Meanwhile, the control circuit 80, in a transmission mode, causes the selection circuit 60 to select any one of the coil-side ends, or any plurality number of adjacent or non-adjacent coil-side ends, or all of the coil-side ends. Further, the control circuit 80 controls the output circuit 40 to cause the first frequency electromagnetic wave to be emitted from the transmitting and receiving coil(s) 20 connected to the selected coil-side end(s).

Thereafter, the control circuit 80, in the receive mode, causes the selection circuit 60 to select any one of the coil-side ends (e.g., one selected at the transmission mode), or a plurality of adjacent or non-adjacent coil-side ends (e.g., the plurality ones selected at the transmission mode), or all of the coil-side ends. The control circuit 80 then receives the induced voltage generated by the transmitting and receiving coil(s) 20 connected to the selected coil-side end(s), and analyzes the peak, intensity, and/or frequency of the received induced voltage to identify whether the resonant circuit R has approached the corresponding transmitting and receiving coil 20 and/or the type of the resonant circuit R which has approached.

Meanwhile, an alternation embodiment of the circuit configuration for selecting a plurality of transmitting and receiving coils is provided. The other ends of the plurality of transmitting and receiving coils forms a common node. The common node is coupled to the coil-side end of a first selection circuit (the first selection circuit has one coil-side end and two circuit-side ends). An output circuit and a receiving circuit are respectively coupled to each circuit-side end of the first selective circuit. The one ends of each transmitting and receiving coil are coupled to a plurality of coil-side ends of a second selection circuit (the second selection has a plurality of coil-side ends corresponding to the number of the transmitting and receiving coils, and one circuit-side end). Further, the ground or common voltage can be coupled to the coil-side ends of the second selection circuit.

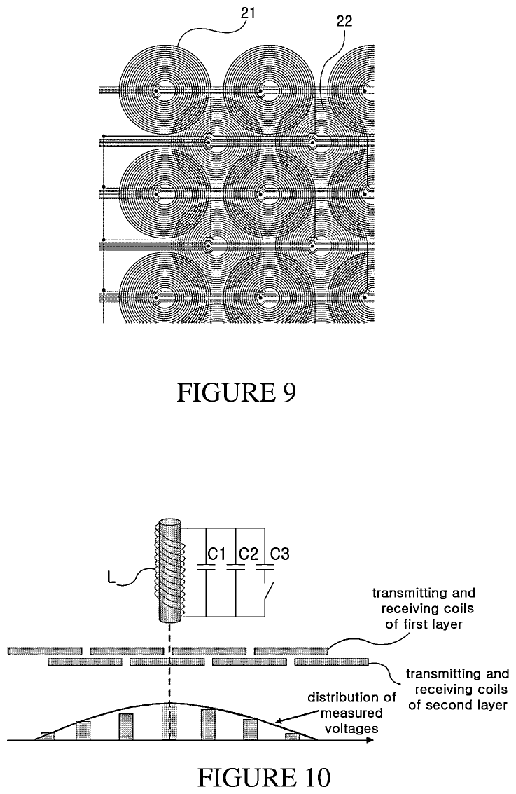

FIG. 9 is a diagram illustrating an embodiment of placing a plurality of transmitting and receiving coils on a plane, when the plurality of transmitting and receiving coils are provided. When a plurality of transmitting and receiving coils 20 are provided, it is desirable to miniaturize and densely arrange the transmitting and receiving coils, if possible, since it is possible to identify the location of the resonant circuit corresponding to the location of each transmitting and receiving coil. For this purpose, in this embodiment, a predetermined area of a substrate is set as a detection area A and on one surface of the substrate that makes up the detection area A, transmitting and receiving coils of the same shape and size, which are densely wound several times into a flat pancake shape, are densely arranged to constitute transmitting and receiving coils 21 of a first layer (corresponding to the coils arranged from the top left in FIG. 9). Further, on the other surface of the substrate or on one side of another substrate, transmitting and receiving coils of the same shape and size as the transmitting and receiving coils 21 of the first layer, are densely arranged to constitute transmitting and receiving coils 22 of a second layer. In this case, the transmitting and receiving coils 22 of the second layer are preferably disposed in portions of empty spaces between the transmitting and receiving coils 21 of the first layer. in FIG. 9, the coils 22 of the second layer are shown as overlapped coils interposed between the coils 21 of the first layer.

In this way, by arranging the transmitting and receiving coils (21) of the first layer and the transmitting and receiving coils (22) of the second layer in such a way that coils are misaligned with each other, the accuracy and precision in detecting the location of the resonant circuit can be improved.

Herein, the transmitting and receiving coils is shown as a circular pancake shape, but as shown in FIG. 3, other shapes such as a rectangular shape are also possible. Furthermore, it is also possible to implement the shape and arrangement density of the transmitting and receiving coils in the first and second layers differently from each other.

FIG. 10 is a diagram illustrating a method for detecting the location of a resonant circuit using the transmitting and receiving coils of the first layer and the transmitting and receiving coils of the second layer disposed such that these coils are misaligned with each other as shown in FIG. 9. When the resonant circuit approaches the transmitting and receiving coils, the maximum electromagnetic induction occurs when the center of the transmitting and receiving coil and the center of the resonant coil of the resonant circuit coincide coaxially, and therefore a transmitting and receiving coil with the centerline closest to the centerline of the resonant coil will generate the maximum induced voltage with maximum efficiency.

FIG. 10 shows that the center of the resonant coil (L) is positioned to be closest to the center of one of the transmitting and receiving coils of the second layer. Therefore, the intensity of the measured induced voltage is maximum at the one of the transmitting and receiving coil of the second layer, while the intensity of the induced voltage at other transmitting and receiving coils therearound decreases with distance therefrom.

In this way, it is possible to detect a transmitting and receiving coil with the maximum induced voltage among the transmitting and receiving coils of the first layer and the transmitting and receiving coils of the second layer, and to determine the location of the center of the detected transmitting and receiving coil as the location of the resonant circuit.

In another way, by analyze the distribution of the intensities of the induced voltages measured from adjacent transmitting and receiving coils, it is also possible to determine any point in the interior of the space created by the positions of the centers of the adjacent transmitting and receiving coils as the location of the resonant circuit.

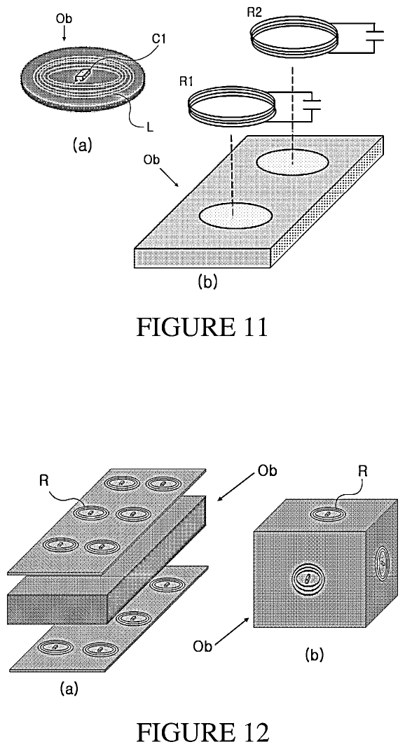

FIGS. 11 to 14 show various examples of implementing an object comprising a least one resonant circuit. A substrate in which a plurality of transmitting and receiving coils 20 are arranged is provided in the form of a flat board, and the flat board has a surface on which an object Ob is placed and the surface serves as a sensing area A.

Part (a) of FIG. 11 shows a coin-shaped marker Ob having a single resonant circuit. Here, a resonant coil L is arranged in a circular shape and a circuit type in which a resonant capacitor C1 is arranged on the inner side of the resonant coil L to simplify the shape of the resonant circuit R1, is shown.

Part (b) of FIG. 11 shows that two resonant circuits R1 and R2 can be arranged in a flat plate-shaped object Ob. The resonant circuits R1 and R2 can have the same resonant frequency or different resonant frequencies.

Part (a) of FIG. 12 shows that substrates each having a plurality of, for example, six, resonant circuits R can be attached to a first face of an object Ob in the form of a flat plate cube and a second face opposing said first face of the object Ob. The six resonant circuits arranged on each substrate can all have the same resonant frequency, or some or all can have different resonant frequencies. Preferably, the resonant frequencies of the resonant circuits of the substrate attached to the first face and the resonant frequencies of the resonant circuits of the substrate attached to the second face can be different. Thus, the control circuit 80 is able to identify the object Ob is placed at which point in the sensing area A and which face of the object is placed on the board.

Part (b) of FIG. 12 shows a structure in which resonant circuits with different resonant frequencies are placed on the respective surfaces of a cube-shaped object Ob. When a regular hexahedron having this structure is placed in the sensing area A, the control circuit 80 can identify a surface of the object that touches the board, and thus the regular hexahedron can be used as a die. Further, another way to arrange the resonant circuits R using different arrangements is to place two or more resonant circuits on one surface, and thereby the control circuit 80 can distinguish each surface on the basis of the number and arrangement of resonant circuits detected.

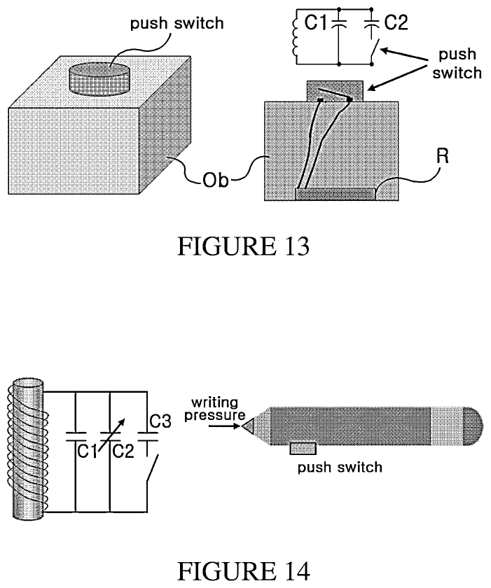

FIG. 13 shows a structure for detecting whether a push switch is operated or not in an object having the push switch. A predetermined resonant circuit R can be arranged at the bottom of the object Ob, and the push switch functions as a switching element which can couple additional capacitor C2 to the resonant circuit R. In such a structure, when the user places the object Ob in the sensing area A, the control circuit 80 can identify the type and location of the object Ob placed in the sensing area A and detect the operation of the push switch when the push switch is operated by the user. Thus, additional functions utilizing the object Ob can be provided.

This object Ob can be, for example, a block for early childhood education. The early childhood can be guided to simultaneously place several blocks having a predetermined shape at predetermined locations in the sensing area A, and can be guided to select a specific block and press a push switch of the specific block. In this way an educational game can be played by determining whether the guided block has been correctly placed and manipulated.

FIG. 14 shows an example of an object implemented in the form of an electronic pen. A resonant coil L of a resonant circuit R is disposed near a tip of the electronic pen; an additional variable capacitor C2 is provided such that the capacitance thereof is varied by writing pressure applied to the tip, and another additional capacitor C3 is connected to a push switch which can be operated by a user while using the electronic pen. In this structure, the location of the electronic pen can be detected by a basic capacitor C1 of the resonant circuit R, the writing pressure can be determined from the resonant frequency varied by the variable capacitor C2, and the operation of the push switch can be determined from the resonant frequency varied by the another additional capacitor C3.

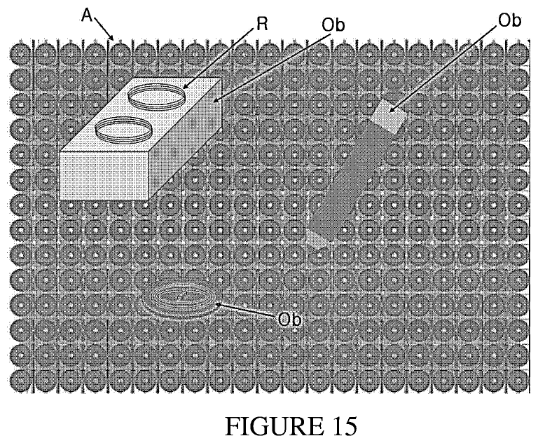

FIG. 15 is a diagram which shows an example of distinguishing various objects using a sensing area incorporating a plurality of transmitting and receiving coils arranged in a first layer and a second layer.

In the sensing area A having the transmitting and receiving coils 21, 22 of the first and second layers misaligned with each other as shown in FIG. 9, various shapes of objects Obs which include resonant circuits arranged in various ways can be detected.

The device 100 for identifying the location and type of an object according to the present invention can detect a resonant circuit in each unit of the transmitting and receiving coils. Therefore, it is possible to simultaneously detect each object Ob in the plurality of transmitting and receiving coils 20 at the same time. However, the simultaneous detection as many as the number of receiving circuits will be possible.

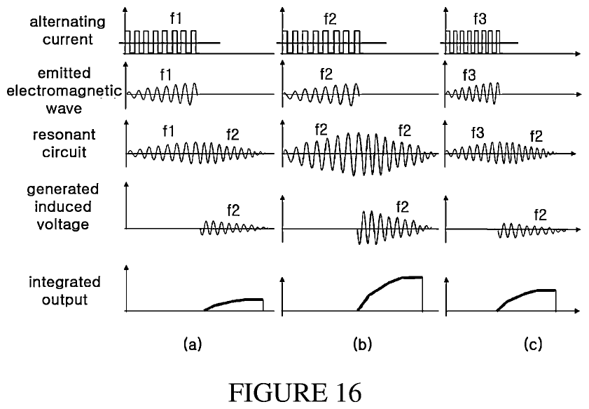

Further, referring to FIG. 16, the operating principle of a device for identifying the location and type of object according to another embodiment of the present invention will be described. The device 100 for identifying the location and type of object described herein has substantially the same configuration as the configurations shown in FIG. 2 and FIG. 8, except that the frequency of the alternating current outputted by the output circuit 40 can be arbitrarily controlled, and the control circuit 80 does not need to identify the frequency of the received induced voltage. Here, the control circuit 80 includes a function for integrating the induced voltage or detecting the peak of the induced voltage instead of identifying the frequency of the induced voltage.

In this embodiment, the control circuit 80 can repeat both the transmission mode and the receive mode two or more times at each of the transmitting and receiving coils 20. In each repeated transmission mode, the frequency of the alternating current outputted through the output circuit 40 is varied. For example, the control circuit 80 can cause an alternating current of a first frequency f1 to be outputted in a first transmission mode and then operate in a first receive mode; cause an alternating current of a second frequency f2 to be outputted in a second transmission mode and then operate in a second receive mode; and cause an alternating current of a third frequency (f3) to be outputted in a third transmission mode and then operate in a third receive mode.

The control circuit 80 can measure the peaks or intensities of the received induced voltages in each receive mode. Preferably, the received induced voltages can be integrated over a predetermined period of time or during the receive mode to generate an integral output.

After operating in a plurality of transmission and receive modes, a case at which the largest peak or intensity or integrated output of the induced voltages received in each receive mode is appeared can be determined, and the frequency of the alternating current outputted at that case can be identified. The identified frequency can be determined as the frequency of the resonant circuit now approaching the transmitting and receiving coil.

FIG. 16 shows a method for determining the resonant frequency in the above way, assuming that the resonant frequency of the resonant circuit is the same or nearly the same as the second frequency F2.

In part (a) of FIG. 16, when an alternating current of the first frequency f1 is applied to a transmitting and receiving coil 20 in the transmission mode, electromagnetic waves of the first frequency f1 are emitted from the transmitting and receiving coil 20. A resonant circuit R of the object resonates at the first frequency f1.

When applying of the alternating current is stopped in the receive mode, the resonant circuit R of the object emits electromagnetic waves corresponding to its own resonant frequency (here, it can be a second frequency f2), and then an induced voltage of the second frequency f2 is generated in the transmitting and receiving coil 20.

The generated induced voltage is integrated to produce a low integrated output as shown in the bottom graph.

In part (b) of FIG. 16, when the alternating current of the second frequency f2 is outputted through the output circuit 40 in the transmission mode, the electromagnetic wave of the second frequency f2 is emitted from the transmitting and receiving coil 20 to the air, and then the resonant circuit R resonates at the second frequency f2.

In the receive mode, the resonant circuit R also emits electromagnetic waves at the second frequency f2, and the transmitting and receiving coil 20 generates an induced voltage at the second frequency f2 due to the emitted electromagnetic wave at the second frequency f2.

The generated induced voltage is integrated to produce a significantly high integrated output as shown in the bottom graph.

In part (c) of FIG. 16, in the transmission mode, when an alternating current at the third frequency f3 is outputted from the output circuit 40, an electromagnetic wave of the third frequency f3 is emitted into the air from the transmitting and receiving coil 20, and then the resonant circuit R resonates at the third frequency f3.

In the receive mode, the resonant circuit R will emit electromagnetic waves with its own resonant frequency, which is a second frequency f2. Due to emitted electromagnetic wave at the second frequency F2, the transmitting and receiving coil 20 will also generate an induced voltage of the second frequency F2.

The generated induced voltage is integrated to produce a relatively low integrated output as shown in the bottom graph.

After repeating both the transmission mode and the receive mode three times, the case with the maximum integrated output can be found. Referring to FIG. 16, the maximum integrated output was obtained when the alternating current of the second frequency f2 was outputted, and thus the resonant circuit of the object which now approaches the transmitting and receiving coil can be considered to have a resonant frequency of the second frequency f2.

If the resonant frequency of the object is equal to or close to the first frequency f1, the maximum integrated output will appear when the alternating current of the first frequency f1 is outputted.

In this way, by identifying the resonant frequency of the object now approaching the transmitting and receiving coil, the object can be distinguished.

Further, even in the case of applying multiple transmitting and receiving coils as in FIG. 8, it is possible to identify which resonant circuit has approached each transmitting and receiving coil by repeating multiple rounds of transmission mode-reception mode for each transmitting and receiving coil.

As an alternative embodiment, it is also possible to distinguish the resonant circuit with only one or minimal repetition of the transmission mode—reception mode without performing multiple repetitions of the transmission mode—the receive mode on a single transmitting and receiving coil.

In other words, a method can be considered, wherein the method comprises steps for using an alternating current with a predetermined frequency to emit an electromagnetic wave; generating the integrated output from an induced voltage generated by the received electromagnetic wave, and if the generated integrated output is equal to or greater than a predetermined threshold value, determining that the predetermined frequency matches the resonance frequency of the resonant circuit.

Another method is to combine the method of distinguishing objects by emitting an electromagnetic wave with a fixed first frequency and then analyzing the frequency of the received electromagnetic wave, and the method of distinguishing objects by varying the frequency of an emitting electromagnetic wave and then analyzing the intensity of the received electromagnetic wave.

1. A device for identifying the location and the type of an object, the device comprises:
a plurality of transmitting and receiving coils each composed of a wire wound concentrically and a plurality of times in form of a spiral shape, wherein the plurality of transmitting and receiving coils are have the same shape and size and are arranged in a horizontal-vertical grid pattern in a first layer of a substrate;
a selection circuit composed of coil-side ends connected to one ends of the plurality of transmitting and receiving coils, a first circuit-side end, and a second circuit-side end, and configured to selectively couple one or more of the one ends of the wire of the transmitting and receiving coil to either one of the first circuit-side end and the second circuit-side end of the selection circuit;
an output circuit configured to apply an alternating current of a first frequency to the first circuit-side end;
a receiving circuit configured to receive an induced voltage applied to the second circuit-side end; and
a control circuit configured to:
control the operation of the selection circuit such that the selection circuit couples the output circuit to at least one of the one ends of the plurality of transmitting and receiving coils in a transmission mode and couples the receiving circuit to the at least one of the one ends of the plurality of transmitting and receiving coils in a receive mode;
in the transmission mode, control the output circuit to apply the alternating current of the first frequency to the first circuit-side end;
in the receive mode, determine which of the plurality of transmitting and receiving coils has been approached by a resonant circuit in an object by analyzing the peak or the intensity of the induced voltage received by the receiving circuit for each of the plurality of transmitting and receiving coils,
wherein the object has one or more resonant circuit, and each resonant circuit is configured to generate energy by resonating with the electromagnetic wave at the first frequency emitted from the transmitting and receiving coil in the transmission mode, and to emit electromagnetic waves having its own resonant frequency by the generated energy when emission of the electromagnetic waves at the first frequency is stopped in the receive mode.

2. The device according to claim 1, wherein
the object comprises:
a first resonant circuit which is designed to have the same resonant frequency as the first frequency, and includes at least one of first resonant coils and at least one of first resonant capacitors; and
a second resonant circuit which is designed to have different resonant frequency from the first frequency and includes at least one of second resonant coils and at least one of second resonant capacitors; and
the control circuit is configured to:
determine locations of the first resonant circuit and the second resonant circuit by analyzing results of identifying the first frequency and the second frequency based on results of analysis of the peaks and intensities of the induced voltage received from each of the plurality of transmitting and receiving coils, and
identifies the type of the object based on the arrangement of the first resonant circuit and the second resonant circuit in the arrangement of the horizontal-vertical grid pattern of the plurality of the transmitting and receiving coils.

3. (canceled)

4. The device according to claim 1, wherein
each of the other ends of the plurality of transmitting and receiving coils are coupled to a common voltage.

5. The device according to claim 1, wherein
the plurality of transmitting and receiving coils comprises transmitting and receiving coils of a first layer which are arranged in a horizontal-vertical grid pattern on a first surface of the substrate and transmitting and receiving coils of a second layer which are arranged in horizontal-vertical grid pattern on a second surface of the substrate, centers of the transmitting and receiving coils of the first layer and the transmitting and receiving coils of the second layer being misaligned with each other.

6. The device according to claim 31, wherein
the control circuit is configured to cause all of the plurality of transmitting and receiving coils to simultaneously emit electromagnetic waves at the first frequency by simultaneously coupling all of the plurality of transmitting and receiving coils to the output circuit, in the transmission mode, and
the control circuit is configured to simultaneously select at least two transmitting and receiving coils that are not adjacent to each other and to analyze induced voltages from the at least two transmitting and receiving coils, in the receive mode.

7. (canceled)

8. The device according to claim 72, wherein
the at least one resonant capacitor of the first resonant circuit and the second resonant circuit further comprises:
a variable capacitor the capacitance of which is varied by an external physical force, or
an additional capacitor that is coupled in series or in parallel to the resonant capacitor by the external physical force.

9. The device according to claim 1, wherein
the control circuit is configured to cause the at least one of the plurality of transmitting and receiving coils to operate the transmission mode and the receive mode a plurality of times, and
in each time of the repetitions, the control circuit is configured to:
in the transmission mode, cause the output circuit to output alternating currents of different frequencies such that electromagnetic waves of the different frequencies are transmitted from the at least one of the plurality transmitting and receiving coils; and
in the receive mode, analyze the peak or the intensity of the received induced voltage and determine the resonant frequency of the resonant circuit which approach the at least one of the plurality transmitting and receiving coils among different frequencies of the alternating currents, and thereby identifies the resonant circuit.
